(19) United States
(12) Patent Application Publication
(10) Pub. No.: US 2004/0172373 A1
(43) Pub. Date: Sep. 2, 2004

(54) Method and system of range-based floating pricing for electronic transaction

(76) Inventor: Shuwei Chen, San Marcos, TX (US)

Correspondence Address: Mr. Shuwei Chen, 1200 Mountain View, San Marcos, TX, 78666, US

(21) Appl. No.: 10/375,661

(22) Filed: Feb. 28, 2003

(51) Int. Cl. G06F 17/60

(52) U.S. Cl. 705/400; 705/26

(57) ABSTRACT

A method and system that allows users to trade items over the Internet with dynamic pricing model is disclosed. The method and system enables a seller to post an item for sale with dynamic pricing settings. The dynamic pricing settings comprise price range, pricing algorithm and price-updating interval Over the item's listing period, the method and system automatically schedule to run the pricing algorithm to update the listing price every price-updating interval and the listing price is floating within the price range. A buyer can place an order on an item and finish the transaction at anytime before the end of the listing period. A buyer can trade directly online or set up an agent to conduct trading on behalf of the buyer.

### FIELD OF THE INVENTION

The present invention relates to Internet-based electronic commerce and business. More particularly, the invention relates to dynamic-priced online trading, such as online auction, online haggle and online group shopping.

### BACKGROUND

Currently, online trading has been widely accepted by sellers and buyers. According to pricing models, online trading activities fall into two major categories: fixed-priced trading and dynamic-priced trading. In a fixed-priced trading, item price is pre-defined by seller and price value is fixed; in a dynamic-priced trading, item price is not a fixed value but it can be updated by following certain rules with or without traders' interaction. The biggest challenge for a fixed-priced trading is how a seller to price an item properly? If the price is too low, the seller doesn't make much profit; if the price is too high, it is less likely to lead to a deal. Dynamic-priced trading provides a solution to this challenge by letting both seller and buyer get involved in the pricing process. Hence, the price is more acceptable to both trading parties when a dynamic-priced trading model is used.

Online auction is one of the most popular trading models in the dynamic-priced trading model family. In a typical online auction, an item is listed for several days or weeks while the item price is usually bidden up as buyers place their bids. When the auction is up to close, the buyer who places the highest bid becomes the winner. While online auction enjoys its great success, it has unsolvable problems.

The most fundamental problem with online auction is that it benefits sellers more than it does buyers because an item's final price is a result from buyers' competition. For example, one seller posts a computer laptop for auction with the initial price of $100. Buyer A places a bid of $110. In order to bid buyer A out, other buyers will have to place bids higher than $110. The more buyers participate in the auction, the higher the price is; and the price will never fall down again. While sellers always welcome higher prices, buyers wish exactly the opposite.

To avoid bidding the price up, many online auction buyers prefer to wait till the last minutes to place their bids. However, due to the speed of network, the time and the order for the auction server to receive bids is undetermined. For example, buyer A, B, and C are all wait till the last minute to bid. Buyer A submits the bid before Buyer B and Buyer B submits the bid before Buyer C. But, the auction server receives Buyer C's bid first, and the auction is closed and buyer C becomes the winner. At the same time, buyer A and B might not be notified instantly due to computer network system delay and might still be struggling to make offers. The above-stated scenario will be much less likely to happen if buyers don't compete for the winning price.

Another problem with online auction is related to time. Online auction has to last for a certain period to let buyers bid the price up. No matter how early a buyer makes an offer, the buyer will have to wait till the closing time to close the deal. Some auction adds a feature to let the buyers to buy the item at a fixed price. But the item is really not a dynamic-priced item any more in this scenario. And the seller will face the same problem as with a fixed-priced item: how to price an item properly?

The present invention, as a new dynamic pricing model, solves the above problems that online auction has.

### SUMMARY OF THE INVENTION

It is an object of the present invention to provide a method and system that replaces expensive and time consuming traditional on-site trading with a far more efficient manner of trading goods and service electronically over a network such as Internet.

It is another object of the present invention to provide a method and system that offer sellers an easy and effective pricing solution that more likely lead to a deal than fixed-pricing ones do.

It is a further object of the present invention to provide a method and system that could lead to a deal at the seller's most desirable price.

It is still an object of the present invention to provide a method and system that every buyer could have the opportunity to buy an item at the lowest price in seller's price range anytime.

It is an additional object of the present invention to provide a method and system that traders can finish the transaction right after the order is placed and confirmed.

It is a further object of the present invention to provide a method and system that updates item prices automatically on behave of sellers based upon certain rules with or without traders' interaction.

It is still an object of the present invention to provide a method and system that allow a buyer to trade directly online or set up an agent to conduct trading on behalf of the buyer.

To achieve the above-stated and other not-stated features, advantages and objects of the present invention, an embodiment of the present invention makes use of computer hardware and software to enable users, such as buyers, sellers and brokers of goods and/or services of all types, to communicate and trade with one another over a global network, such as Internet. A seller posts items into a computer server in the system with dynamic pricing settings. The server schedules to update item prices over the listing period. A buyer can access to the server to get item information. A buyer can place orders at their terminals remotely or set up a buyer agent on the server to conduct trading on behalf of the buyer.

An item's dynamic pricing settings comprise price range, pricing algorithm, price-updating interval and other optional setting.

The price range is the seller's acceptable selling price range from a minimum price to a maximum price. For example, the price range of a computer laptop could be $200-$300.

The pricing algorithm is any algorithm that can generates a new price independent of previous prices with the new price staying within the price range. And these kinds of algorithms are called range-based floating pricing algorithms in this invention. The term of “floating” means that it is impossible to predict a new price value from the previous prices. For example, if the current price is $30 and the price range is $20-$40, the new price could be higher or lower than or equal to $30, but it will be within the range of $20-$40.

The price-updating interval specifies how often an item price is updated. An item price will stay unchanged during the price-updating interval since the most recent price updating (The first updating time is the item posting time). For example, if the price-updating interval for an item is 2 hours, the item price will not be updated within 2 hours since the most recent price updating.

The initial price for an item could be provided by the seller at the posting time or be generated by the pricing algorithm after posting. Once the item is posted into the server successfully, it is up to the server to run the pricing algorithm periodically to update the item price.

A buyer can either place an order directly or set up a buyer agent to conduct the trading on behalf of the buyer. A buyer agent is a computer program running at the server. A buyer agent can conducts trading on behalf of a buyer so that the buyer does not need to spend all the time in the trading environment waiting for a right price.

On the one hand, for each individual buyer, an item is a fixed-priced item because the listing price is the deal price and is ready for a trading transaction anytime. On the other hand, the same item is also a dynamic-priced item because the item price keeps updated over the listing period. Moreover, every buyer might buy the item at the lowest price of the seller's price range.

Range-based floating pricing is an ideal dynamic pricing model for both sellers and buyers.

For sellers,

The price is always in the price range; so they don't need to worry about how to price the item properly in a fixed value.

When the price is floating, it is possible to lead to a deal at a high price in the price range.

The fact that every buyer has a chance to buy an item at the lowest price in the price range will attract bargain buyers; so the chance to lead to a deal is good.

For buyers,

Every buyer has a chance to buy an item at the lowest price of the price range anytime during the listing period.

A buyer can place an order and finish the transaction anytime. There is no need to wait till the closing time.

A buyer's decision of making an offer is totally in the hand of the buyer as related to the buyer's acceptance level with the current price. Buyers do not need to compete for the luck with network speed.

Additional objects, advantages and novel features of the present invention will be set forth in part in the description which follows. Furthermore, and in part will become more apparent to those skilled in the art upon examination of the following or may be learned by practice of the invention.

### BRIEF DESCRIPTION OF THE FIGURES

FIG. 1 is a schematic diagram of a sample system for an embodiment of the present invention. It illustrates the key components and the information flow between the key components of the system for an embodiment of the present invention;

FIG. 2 shows a sample item with range-based floating pricing setting for an embodiment of the present invention;

FIG. 3 shows two sample range-based floating pricing algorithms for an embodiment of the present invention;

FIG. 4 shows a sequence diagram of an item price updating process for an embodiment of the present invention;

FIG. 5 shows a schematic diagram illustrating an example of a buyer agent for an embodiment of the present invention.

### DETAILED DESCRIPTION

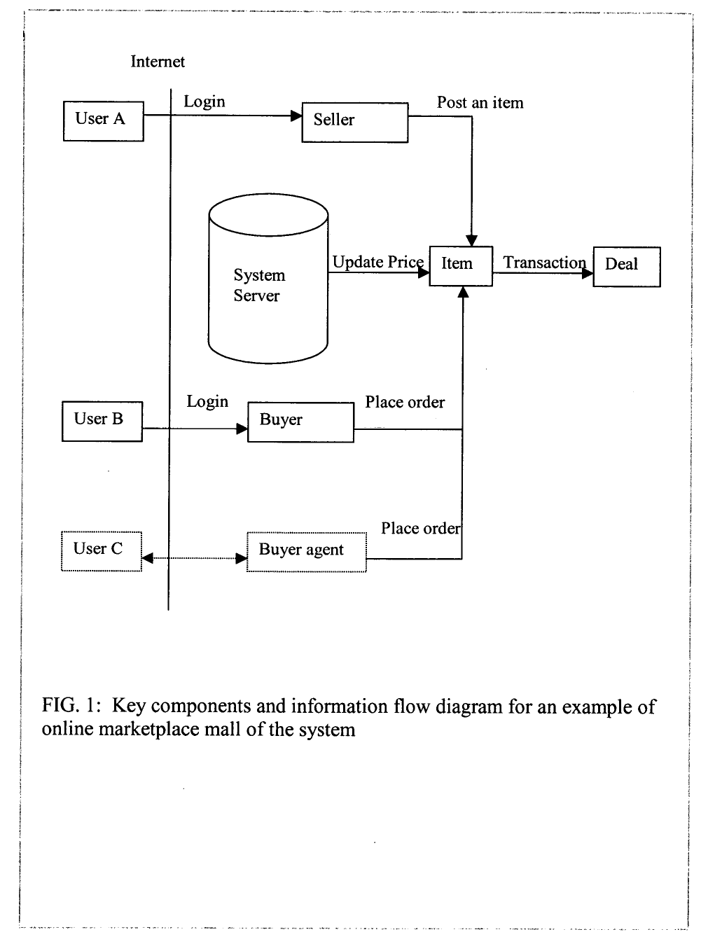

FIG. 1 is a schematic diagram, which illustrates the key components and the information flow between the key components of a sample system for an embodiment of the present invention.

The dynamic pricing model described in this invention, called range-based floating pricing model, can be applied on both online retailer store and online marketplace mall. In an online retailer store scenario, the online store manager is the seller and only buyers of the trading party are customers; in an online marketplace mall scenario, system administrators manage the system and both sellers and buyers are customers of the online marketplace mall. The system showed in FIG. 1 is an online marketplace mall.

Referred to FIG. 1, a seller logs into the system with proper credentials over a network. Once a seller login, the seller can post an item for sale. Typically, the seller needs to pick an item category and provide a detailed item description so that buyers can find the item easily and have a throughout knowledge about it. And the seller is required to provide dynamic pricing settings, which are needed for dynamically pricing the item. The dynamic pricing settings comprise price range, pricing algorithm, price-updating interval and other optional setting. A seller can review all the item information before submitting it to the system.

The initial price for an item could be provided by the seller at the posting time or be generated by the pricing algorithm after posting. Once the item is posted into the server successfully, it is up to the system to schedule to run the pricing algorithm to dynamically price the item. When and how an item price is updated is decided by the item's pricing setting.

A buyer can either place an order directly or set up a buyer agent to conduct the trading on behalf of the buyer. A buyer agent is a computer program running at the system server. With a proper setting, a buyer agent can behave like a real buyer to perform various types of operations. For example, an agent can place an order on behalf of the buyer when the buyer's criteria satisfied, or it can send out an email notification to the buyer about the pricing and other transaction information as required by the buyer.

An order process typically involves specifying the item quantity, applying any coupons, placing an order, reviewing the order and confirming the order.

After an order is confirmed successfully, the deal is done. Both the seller and the buyer are obligated to the deal.

There are other useful and important components for the invention (although not shown in FIG. 1), which comprise trading tutorial, trading history, customer service, and feedback area, etc.

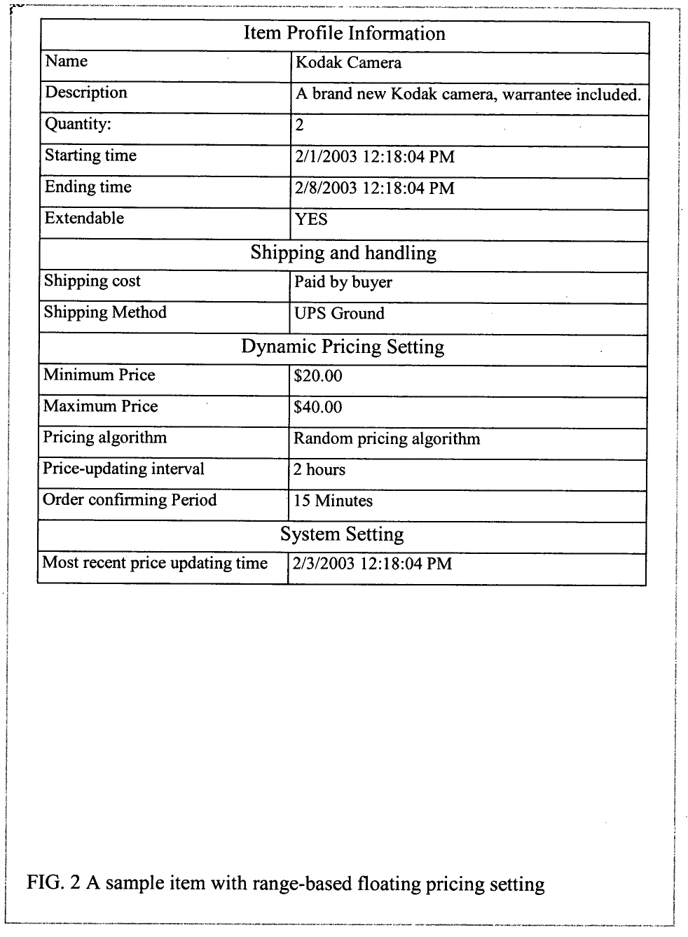

FIG. 2 shows a sample item for an embodiment of the present invention. In this sample, the item is posted as a new Kodak camera. There are four sections of information about the item. The first section is the item profile information, such as name, description, quantity, and listing time. The second section is about shipping and handling information. The third section describes the dynamic pricing setting of this item. An item's dynamic pricing settings comprise price range, pricing algorithm, price-updating interval, and other optional setting. The fourth section describes some system settings created by the system after the item is posted, which are needed only by the system.

The price range is a range between a minimum price and a maximum price. Typically, the minimum price is the seller's least acceptable price and the maximum price is the seller's most desirable price. A seller needs to be careful when defining the price range for an item. The lower the minimum price, the better chance that a deal can be made, but also the more possible that the item could be sold under-priced. On the contrary, the higher the maximum price, the better chance that the item can be sold at a good price, but also the less chance that a deal can be made. Moreover, the price range should NOT be too narrow; otherwise the price difference may not demonstrate the advantage of dynamic pricing model over fixed pricing model.

A good pricing strategy is to combine the price range and the pricing algorithm properly. The price range should be wide enough, and the pricing algorithm will make sure that item prices will mainly stay within the seller's preferred price range but also could touch the low end of the range to attract buyers. In the example illustrated by FIG. 2, the minimum acceptable price is $20 and the maximum desirable price is $40, so the price range for this item is $20-$40.

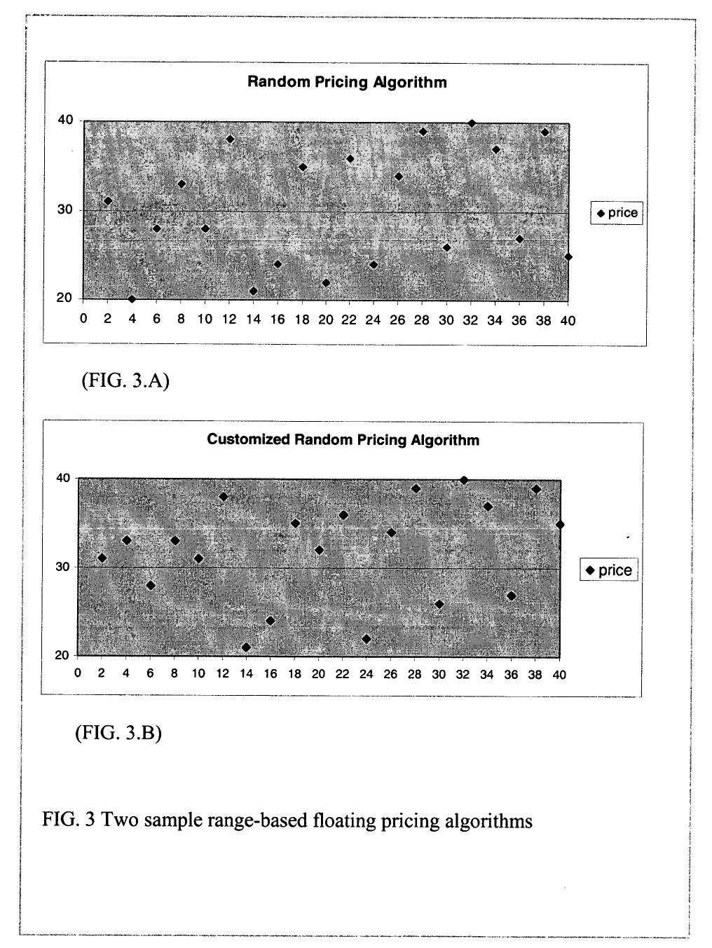

The pricing algorithm can be any algorithm that generates new price independent of any previous prices with the new price staying within a predefined price range. In the example illustrated by FIG. 2, the pricing algorithm is a Random Pricing algorithm. Basically, this Random Pricing algorithm randomly generates new prices, and all prices generated stay within the $20-$40 range. More details about pricing algorithms will be covered when FIG. 3 is described.

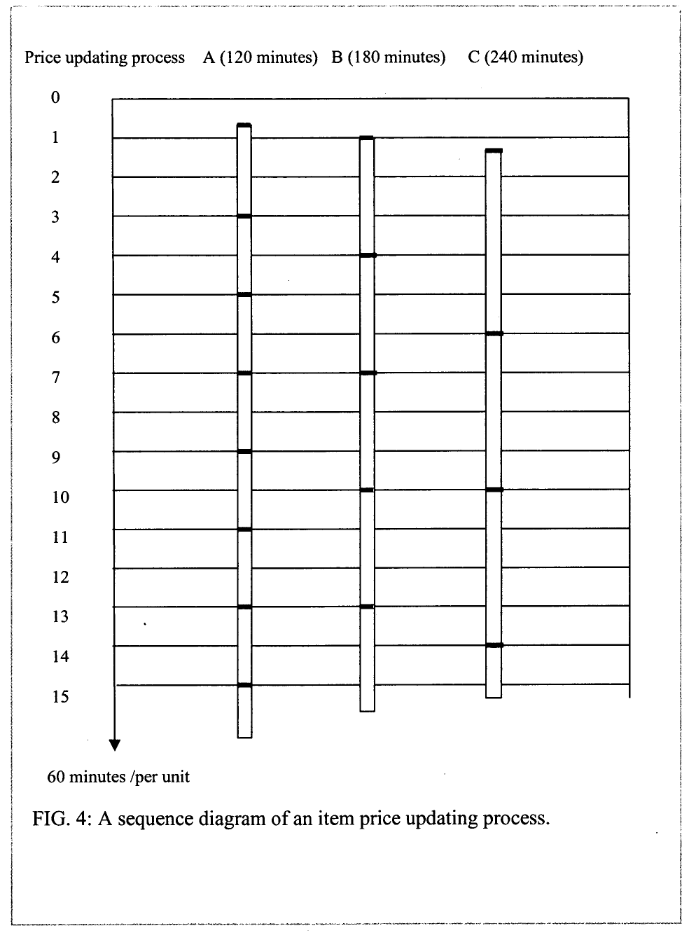

The price-updating interval is a time period during which the item price stay unchanged since the most recent price updating. In the example illustrated in FIG. 2, the price-updating interval is 2 hours, which means the item price will stay unchanged during 2 hours period after every price updating. A reasonable price-updating interval is important. If the period is too short, the price changes too often, buyers will have difficulty keeping tracking of the latest price; if the period is too long, this invention will lose its advantage over the fixed-priced trading. Current computer technology could also be a factor when defining a proper price-updating interval. More issues on price-updating interval will be discussed when FIG. 4 is described.

The order confirmation period is one optional but very important pricing setting. Due to the nature of online trading, it may take some time for a buyer to finish the ordering process (from placing an order to confirming this order). In the range-based floating pricing model, it is possible that an item's price is updated by the pricing algorithm during an ordering process. The order confirmation period is a time period designed to keep the order price valid throughout the whole ordering process. During an order confirmation period, both buyer and seller will be able to keep the order price even the listing price might have been changed. An order confirmation period starts the time when the order is placed and ends after a reasonable time period during which a normal ordering process can be finished. The order confirmation period is not supposed to be very long. It should only cover the period from placing an order to confirming this order. The suggested confirm period is 15 minutes, as adopted by the example in FIG. 2.

If an order confirmation period is not provided, the default value of 0 minutes will be enforced. In this situation, certain actions could be taken. Different implementation of the range-based floating pricing model may take different actions. For example, in one implementation, if the order confirmation period is not set and the item price changes during the ordering process, the ordering process could be aborted.

After an item is posted into the system, some system attributes will be added to the item. For example, the system keeps track of the most recent price-updating time, which will be used together with price-updating interval to determine the next price-updating time. The item posting time is the first price updating time. These attributes are accessible only to the system.

FIG. 3 shows two sample range-based floating pricing algorithms for an embodiment of the present invention. In this invention, a pricing algorithm can be any algorithm that generates new price independent of any previous prices with the new price staying within a predefined price range. All algorithms showing this capability are called “range-based floating pricing algorithm” in this invention. Prices independence and price range are two of most important characteristics of this invention to distinct itself from other dynamic pricing model.

FIG. 3. A shows a diagram of the output of a Random Pricing Algorithm over 20 updating intervals. In this Random Pricing algorithm, the price-updating interval is 2 hours, and the price range is $20-$40. A new price is generated randomly every 2 hours and the new price is always within $20-$40 range. This is probably one of the simplest range-based floating pricing algorithms because it does not need input parameters but a price range.

FIG. 3.B shows a customized Random Pricing Algorithm. In this algorithm, prices are randomly generated and a new price has 70% of chance to fall into the $30-$40 range and 30% of chance to fall into the $20-$30 range. This is an advanced algorithm and it needs price allocation percentage along with a price range.

As mentioned earlier, it is a good pricing strategy to combine the price range and the pricing algorithm properly. For example, referring to FIG. 2, the item is a new Kodak camera, the price range is $20-$40 but the pricing algorithm is changed to the customized Random Pricing Algorithm as illustrated in FIG. 3.B. With this customized algorithm, the item price will be above $30 during 70% of listing period; but the price could be as low as $20 as well. The fact that a brand new Kodak camera could be sold for only $20 is a good advertisement and will attract lots of camera buyers. As long as buyers come to this online mall, some buyers may not bother to shop around anymore and may end up buying this camera at a price of $32.

More complicated algorithms can take buyers' interaction into account. For example, the web page of a popular item typically has a high page-viewing rate and the item's web page-viewing rate could be one factor for an algorithm to generate a new price. More algorithms could be introduced into the range-based floating pricing algorithm family to meet users' requirement.

After an item is posted into the system, it is up to the system to schedule to run the pricing algorithm to update the item price automatically. A computer process, called price-updating engine, is a computer program that keeps running on a computer server of the system as the long as the server is up. The price-updating engine will stay idle most of the time but it will wake up periodically to update the item prices by running their pricing algorithms. The price-updating interval of posted items will decide the waking-up period of the price-updating engine. The waking-up period is the maximum integer that is divisible by all price-updating intervals. For example, if three price-updating intervals are 30, 60, and 90 minutes respectively, the waking-up period should be 30 minutes. This rule will guarantee all item prices to be updated in time at the least cost of system resources.

As mentioned before, the price-updating interval of an item should not be too short because it will make buyers difficult tracking the updating prices. From the point view of the price-updating engine, if the price-updating interval is too short, the price-updating engine has to wake up frequently and this operation will costs lots of computer resources and could further affect the whole system's performance, and even worse, a very short interval maybe not long enough to update the prices of all items. Based on the current computer technology, the minimum price-updating interval should be no less than 1 minute, and the suggested price-updating interval is 2 hours.

However, as mentioned before, the waking-up period is the maximum integer divisible by price-updating intervals of all items. So, even if the price-updating interval of each individual item is long enough, it is still possible the waking-up period of the price-updating engine is too short. For example, if three price-updating intervals are 120, 137, and 249 minutes respectively, the maximum integer divisible by these three numbers is 1. To prevent this kind of scenario happen, one of good practices is to pre-define a set of price-updating interval. When a seller provides the price-updating interval for an item, the seller has to choose one value from the set. By this way, the minimum price-updating interval and therefore the price-updating engine's waking-up period is pre-decided.

FIG. 4 shows a sequence diagram of an item price updating process for an embodiment of the present invention. In this example, there are three items, A, B, and C. Their price-updating intervals are 120, 180, and 240 minutes respectively. The waking-up period of the price-updating engine is 60 minutes. In the diagram, one waking-up period unit denotes 60 minutes. The following is the description of the updating process:

At the waking-up times 1st, Item A has been posted for a while; Item B is just posted; the posting time is marked as the most recent price updating time for both of Item A and B; both of them are in their price-updating interval. There is no price updating.

At the waking-up times 2nd, Item C has been posted and the posting time is marked as the most recent price updating time. But three of items are all in their price-updating interval. There is no price updating.

At the waking-up times 3rd, Item A is beyond the price-updating interval, so Item A's price is updated and the updating time is marked as the most recent price updating time. There is no price updating for Item B and C.

At the waking-up time 4th, Item B is beyond the price-updating interval, so Item B's price is updated and the updating time is marked as the most recent price updating time. There is no price updating for Item A and C.

At the waking-up time 5th, Item A is beyond the price-updating interval, so Item A's price is updated and the updating time is marked as the most recent price updating time. There is no price updating for Item B and C.

At the waking-up time 6th, Item C is beyond the price-updating interval, so Item C's price is updated and the updating time is marked as the most recent price updating time. There is no price updating for Item A and B.

It will be self explained how the prices of the three items to be updated for the rest of waking-up times.

It should be noted that for some items, such as item A and C as referred in FIG. 4, the time period from the first updating time to the initial posting time is larger than the item's price-updating interval. This happens because that all items' price-updating intervals need to synchronize with the waking-up period of the price-updating engine. This time-synchronization happens only once for each item at the very beginning of the price updating process and will not fundamentally affect the nature of dynamic pricing model in this invention.

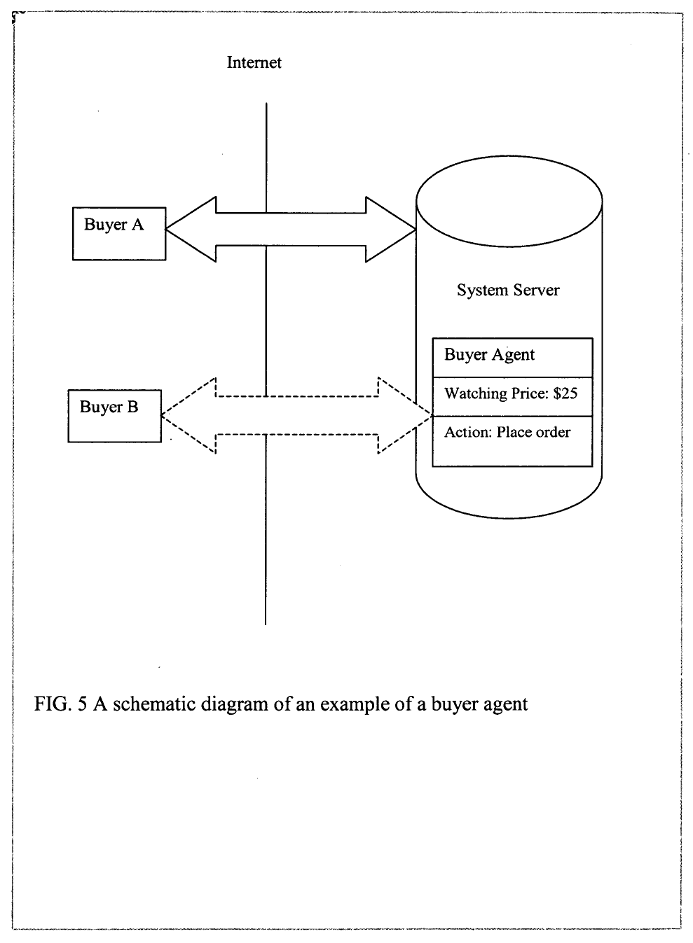

FIG. 5 shows a schematic diagram, which illustrates how a buyer agent works for an embodiment of the present invention. A buyer agent is a computer program that runs at the system server and conducts trading on behalf of a buyer so that the buyer does not need to spend all the time in the trading environment waiting for a right price. An agent can place an order on behalf of a buyer, or it can send out email notification to a buyer about the pricing and other transaction information. For example, referring to FIG. 2, the item is a Kodak camera with a price range $20-$40. A buyer can set up an agent to place order when the item price is or below $25. The $25 of price set by the buyer agent is referred to the buyer's watching price in this invention.

For certain price-updating intervals, it is possible that there are more than one buyer agent for an item and the item listing price is below to the watching price of all buyers. For example, for the above-mentioned Kodak camera, there are two buyer agents of buyer A and buyer B respectively. And buyer A's watching price is $25; buyer B's watching price $27. When the item's price is updated to $22, both of agents of buyer A and B should place an order, but who should win the deal and in what a price? Different implementations of the range-based floating pricing model could have different rules and therefore make different decision. For example, in one implementation, the buyer with the highest watching price could win at the highest watching price.

The buyer agent is one of the important features for any embodiment of the present invention. Because the item price is floating within a range, buyers may want to track each price update to get the best price. It is a very time-consuming task for buyers. With agent feature, a buyer can be relieved from this burden.

The buyer agent can also be used to establish a price agreement between a seller and a buyer. If an item is not sold during the listing period and there is at least one buyer agent with a watching price on this item, the seller might decide to sell the item at one buyer's watching price. By taking this approach, the seller can increase the sale volume. While sacrificing a little bit on one item's profit, the seller can still make a good profit as a whole if the sale volume is high.

It is also worth to mention that range-based floating pricing model is applicable for both of the traditional dynamic-priced trading and the reverse dynamic-priced trading. In a traditional dynamic-priced trading, a seller is always looking for a higher price for an item as listing time passes. Most of current online dynamic-priced trading, such as the one of the online auction site http://www.ebay.com/, belongs to traditional dynamic-priced trading. In a reverse dynamic-priced trading, a seller is always looking for a lower price as listing time passes. A good example is the common practice of Request for Proposal (RFP) when a company or a government agency searches to contract out project. Everything being equal, a bid with the lowest price/expenses will win the contract.

Various preferred embodiments of the present invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

What is claimed is:

1. A method for trading items over the Internet, comprising the steps of: posting an item information into a computer server by a seller with dynamic pricing settings including price range, pricing algorithm, price-updating interval, and other optional settings; updating item price automatically by a computer process on the server following item's dynamic pricing settings; placing the order by a buyer or by a buyer agent; and confirming the transaction between the seller and the buyer.

2. The method of claim 1, wherein said price range is an acceptable price range from the minimum price to the maximum price for said item.

3. The method of claim 1, wherein said pricing algorithm can be any algorithms that generates new item price independent of any previous prices with the new price staying within said price range for said item.

4. The method of claim 1, wherein said price-updating interval is a time period during which the item price will stay unchanged since the most recent price updating.

5. The method of claim 1, wherein said computer process will schedule to run said item's said pricing algorithm to generate a new price for said item every said price-updating interval.

6. The method of claim 1, wherein said buyer can set up a buyer agent to conduct trading on behalf of said buyer.

7. A system for trading items over the Internet, comprising: means for posting an item information into a computer server by a seller with dynamic pricing settings which comprises: price range, pricing algorithm, price-updating interval, and other optional settings; means for automatically updating the item price; means for placing the order by a buyer or by a buyer agent; and means for confirming the transaction between the seller and the buyer.

8. The system of claim 7, wherein means for posting an item by a seller with dynamic pricing settings comprises a seller's terminal coupled to a server over a network that further connects to the Internet.

9. The system of claim 7, wherein means for automatically updating item price comprises one or multiple computer servers connecting to a network that further connects to the Internet.

10. The system of claim 7, wherein means for placing the order by a buyer comprises a buyer's terminal coupled to a server over a network that further connects to the Internet.

11. The system of claim 7, wherein means for placing the order by a buyer agent comprises one or multiple computer servers connecting to a network that further connects to the Internet.

12. The system of claim 7, wherein means for confirming the transaction between the seller and the buyer comprises buyers and sellers' terminals coupled to servers over a network that further connects to the Internet and one or multiple computer server.
